(19) United States
(12) Patent Application Publication
(10) Pub. No.: US 2015/0352697 A1
(43) Pub. Date: Dec. 10, 2015

(54) RATCHET WRENCH

(71) Applicant: Cheng-Pu Yang, Taichung (TW)

(72) Inventor: Cheng-Pu Yang, Taichung (TW)

(21) Appl. No.: 14/298,883

(22) Filed: Jun. 7, 2014

(51) Int. Cl. B25B 13/46; B25B 23/00; F16D 41/16

(52) U.S. Cl. CPC B25B 13/463; F16D 41/16; B25B 23/0007

(57) ABSTRACT

A ratchet wrench includes a body having a function head which has a first recess, a second recess and a third recess to respectively accommodate a ratchet wheel, a pawl and a switch unit. The ratchet wheel has a toothed portion and the pawl has a driving portion which is engaged with the toothed portion. The driving portion has multiple teeth and multiple curved teeth. The pawl has a curved recess, a protrusion and a contact face. The switch unit has a switch member, an end piece and a resilient member. The switch member controls the movement of the pawl to engage the curved teeth of the pawl with the teeth of the ratchet wheel to allow the ratchet wrench to optionally output torque in two directions.

### BACKGROUND OF THE INVENTION

1. Fields of the Invention

The present invention relates to a ratchet wrench, and more particularly, to a ratchet wrench having a switch unit to control the rotational direction of the ratchet wrench.

2. Descriptions of Related Art

A known conventional ratchet wrench is disclosed in U.S. Pat. No. 8,291,792 and comprises a body, a ratchet wheel, a pawl and a resilient member, wherein the body has a first recess, a second recess and a third recess to respectively accommodate the ratchet wheel, the pawl and the switch unit. The ratchet wheel has teeth defined in the outer periphery thereof and a mounting portion is formed at the center of the ratchet wheel. The pawl has multiple engaging teeth and curved teeth in the front side thereof and. The curved teeth are located at the end of the row of the engaging teeth. The engaging teeth and the curved teeth are used to engage with the teeth of the ratchet wheel. The pawl has a curved face and a reception recess formed in the rear side thereof. A gap is defined between the second recess and the curved face so as to allow the teeth to be disengaged. The reception recess and the curved teeth are located in opposite to each other. The two ends of resilient member are in contact with the inside of the second recess and the reception recess. The resilient member pushes the rear side of the pawl to engage the engaging teeth of the pawl and the teeth of the ratchet wheel to perform the function of a ratchet mechanism. However, the resilient member directly pushes the pawl and the curved teeth are located at the end of the row of the engaging teeth, and the resilient member can only apply the force to the back of the curved teeth so that the ratchet wheel can only rotate in one direction. The direction contact between the pawl and the resilient member is not stable and reliable so that the functions of the ratchet wrench easily fail.

The present invention intends to provide a ratchet wrench to eliminate the shortcomings mentioned above.

### SUMMARY OF THE INVENTION

The present invention relates to a ratchet wrench and comprises a body having a function head which has a first recess, a second recess and a third recess to respectively accommodate a ratchet wheel, a pawl and a switch unit. The ratchet wheel has a toothed portion and the pawl has a driving portion which is engaged with the toothed portion. The driving portion has multiple teeth and multiple curved teeth. The pawl has a curved recess, a protrusion and a contact face. The switch unit has a switch member, an end piece and a resilient member. The switch member controls the movement of the pawl to engage the curved teeth of the pawl with the teeth of the ratchet wheel to allow the ratchet wrench to optionally output torque in two directions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a top view of the body of the ratchet wrench of the present invention;

FIG. 3 is a perspective view to show the pawl of the ratchet wrench of the present invention;

FIG. 4 is a top view to show the pawl of the ratchet wrench of the present invention;

FIG. 5 is a perspective view to show the ratchet wrench of the present invention;

FIG. 6 is a side view to show the ratchet wrench of the present invention;

FIG. 7 is a cross sectional view taken along line A-A in FIG. 6;

FIG. 8 is a top view to show the ratchet wrench of the present invention;

FIG. 9 is a cross sectional view taken along line B-B in FIG. 8, and

FIG. 10 is a cross sectional view taken along line C-C in FIG. 8.

### DETAILED DESCRIPTION OF THE PREFERRED EMBODIMENT

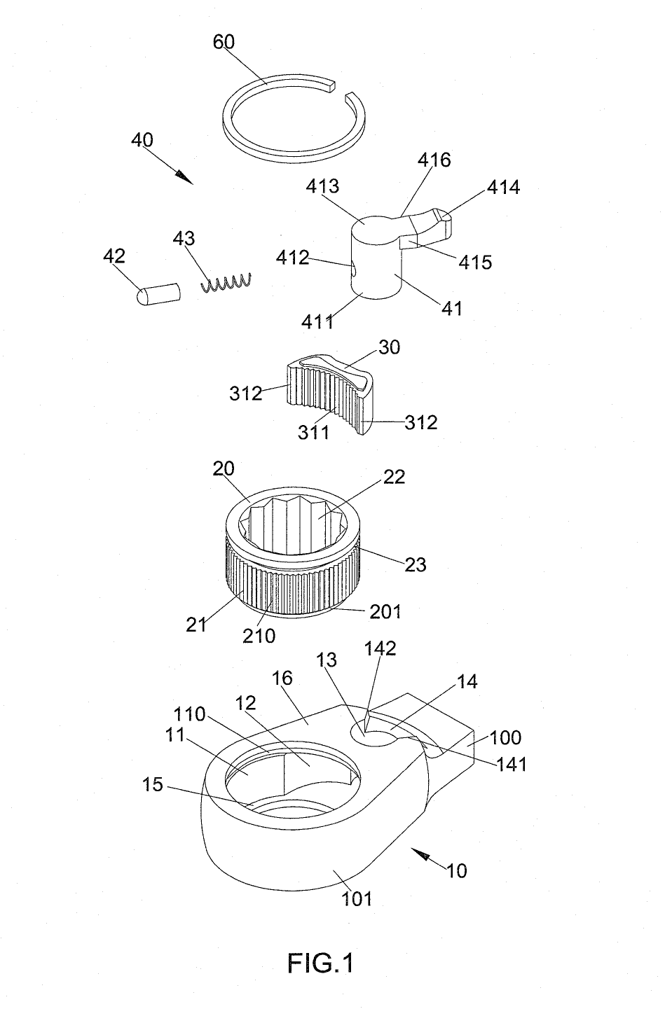

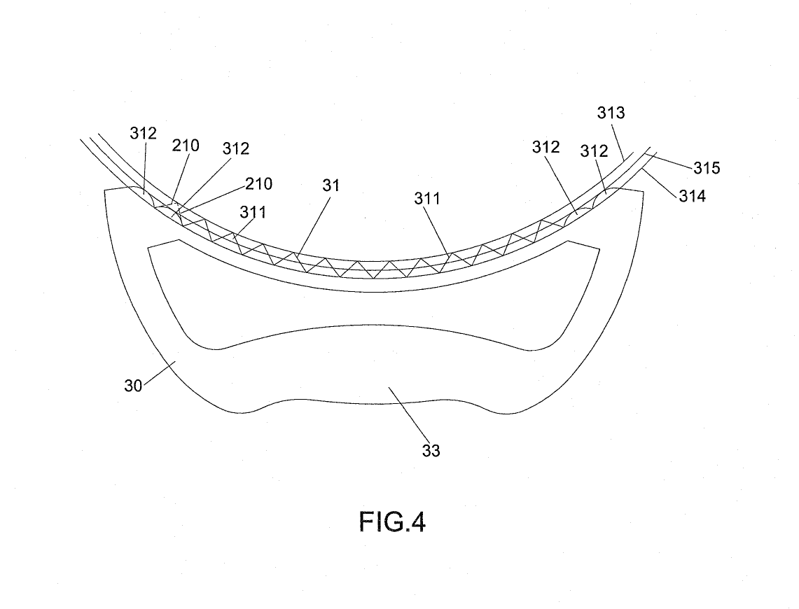

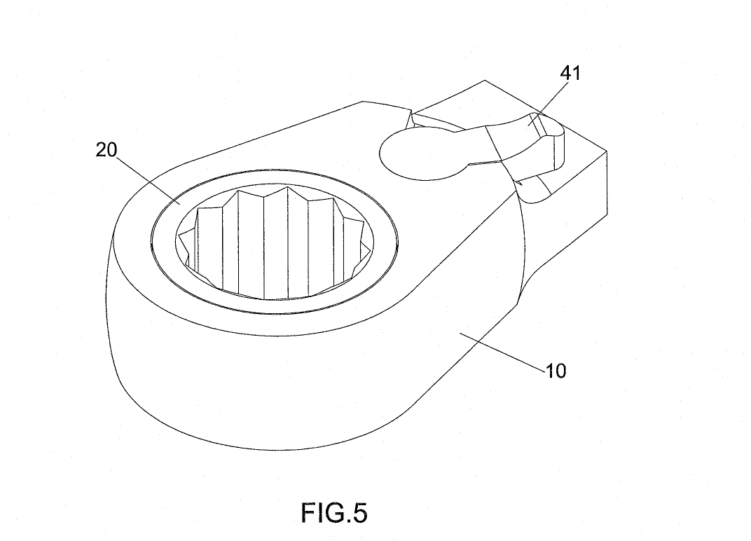

Referring to FIGS. 1 to 4, the ratchet wrench of the present invention comprises a body 10 having a handle 100 and a function head 101 is connected to one end of the handle 100. The function head 101 has a first recess 11 defined therethrough, a second recess 12 is defined in the inner periphery of the first recess 11. The center of the second recess 12 is located within the first recess 11. The second recess 12 has a closed top and a close bottom. A third recess 13 is defined in the inner periphery of the second recess 12 and communicates with the top of the function head 101. The third recess 13 has a center 131 at the center thereof. An opening 14 is defined in the top of the function head 101 and communicates with the third recess 13. The opening 14 is located between a first face 141 and a second face 142. A first angle 144 is defined between the first and second faces 141, 142. The first angle 144 is within a range between 60 to 100 degrees. A groove 110 is defined in the inner periphery of the first recess 11. An extension line from the first face 141 and an extension line from the second face 142 intersects at an intersection point 143. The distance between the intersection point 143 and the first recess 11 is shorter than the distance between the center 131 and the first recess 11. A flange 15 extends inward from the inner periphery of the first recess 11. The function head 10 has an end face 16 on the top thereof.

A ratchet wheel 20 is rotatably received in the first recess 11 and has a toothed portion 21 defined in the outer periphery thereof. The toothed portion 21 comprises multiple teeth 210. An engaging groove 23 is defined in the outer periphery of the ratchet wheel 20. The ratchet wheel 20 has a mounting portion 22 formed at the center thereof wherein the mounting portion 22 is a polygonal recess or a rectangular protrusion. The ratchet wheel 20 has a contact portion 201 at the bottom thereof so as to be in contact with the flange 15 of the body 10.

A pawl 30 is movably located in the second recess 12 and has a driving portion 31 formed in the front side thereof. The driving portion 31 comprises multiple teeth 311 and multiple curved teeth 312. The bottom of each of the teeth 311 and the curved teeth 312 of the pawl 30 is located along a second curve 314. The teeth 311 of the driving portion 31 of the pawl 30 are engaged with the teeth 210 of the ratchet wheel 20. Two to four curved teeth 312 are located at each of two ends of the row of the teeth 311 of the pawl 30. In this embodiment, two curved teeth 312 are located at each of two ends of the row of the teeth 311 of the pawl 30. When the curved teeth 312 are located between two of the teeth 210 of the ratchet wheel 20, the curved teeth 312 are tangent to the two teeth 210 of the ratchet wheel 20. The top of each of the teeth 311 of the pawl 30 is located along a first curve 313. The first curve 313, the second curve 314, the first recess 11 and the ratchet wheel 20 share a common center. A third curve 314 is located between the first and second curve 313, 314. The radius of the third curve 315 is 1/3 to 2/3 of the sum of the radius of the first curve 313 and the radius of the second curve 314. Preferably, the radius of the third curve 315 is a half of the sum of the radius of the first curve 313 and the radius of the second curve 314. The top of each of the curved teeth 312 is tangent to the third curve 315. A curved recess 32 is defined in the rear side of the pawl 30 and a protrusion 33 is located on the upper portion of the curved recess 32. The protrusion 33 has a contact face 34 at the underside thereof. The pawl 30 has a first height 35 and the protrusion 33 has a second height 36 which is smaller than a half of the first height 35, so that the protrusion 33 is slightly smaller than a half of the pawl 30.

A switch unit 40 is located in the third recess 13 to control the movement of the pawl 30 in the second recess 12. The switch unit 40 comprises a switch member 41, an end piece 42 and a resilient member 43. The switch member 41 has a cylindrical member 411 which is rotatably located in the third recess 13. The cylindrical member 411 has a restriction groove 412 which is located corresponding to the curved recess 32. The switch member 41 has a second end face 413 on the top thereof, the second end face 413 is in flush with the first end face 16. A lever 414 extends from the switch member 41 and is located in the opening 14. The lever 414 has a third face 415 and a fourth face 416 respectively formed on two sides thereof. The third face 415 contacts the first face 141, and the fourth face 416 contacts the second face 142. The end piece 42 and the resilient member 43 are located in the restriction groove 412. The resilient member 43 is located between the end piece 42 and the restriction groove 412. The end piece 42 is biased by the resilient member 43 and contacts against the inner side of the curved recess 32. The outside of the end piece 42 contacts the contact face 34 of the pawl 30 to position the switch unit 40 in the third recess 13. The end piece 42 is restricted by the second height 36 of the protrusion 33 to make the end piece 42 aim the central portion of the pawl 30 and the mediate portion of the first height 35.

A C-shaped clip 60 is engaged between the groove 110 of the body 10 and the engaging groove 23 of the ratchet wheel 20 to position the ratchet wheel 20 in the first recess 11.

As shown in FIG. 5, the ratchet wheel 20 is rotatably located in the first recess 11, and the pawl 30 is located in the second recess 12. The second end face 413 of the switch member 41 is in flush with the first end face 16 of the body 10.

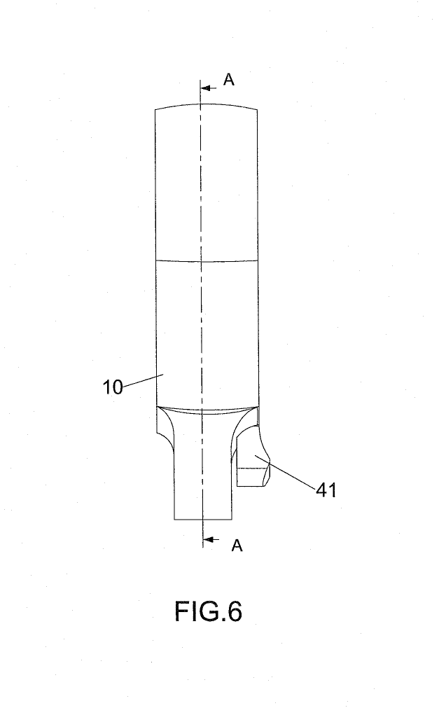

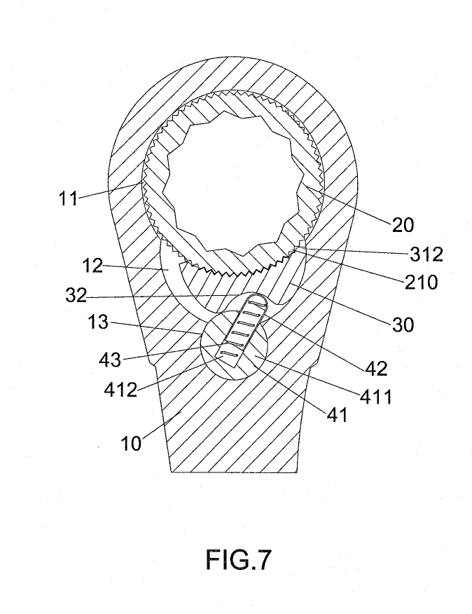

As shown in FIGS. 6 and 7, the driving portion 31 is engaged with the toothed portion 21. The curved teeth 312 are located on two ends of the row of the teeth 311 and tangent to the teeth 210. The switch unit 40 comprises the switch member 41, the end piece 42 and the resilient member 43. The end piece 42 is biased by the resilient member 43 and contacts against the inner side of the curved recess 32. When the user switches the lever 414, the pawl 30 is moved left and right in the second recess 12 to control the rotational direction of the ratchet wrench.

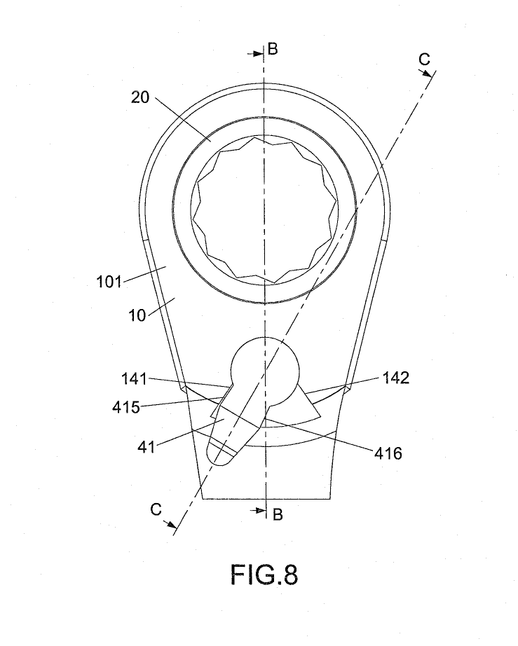

As shown in FIG. 8, when the user switches the lever 414, and the ratchet wrench is rotated clockwise, the first face 141 contacts the third face 415. When the ratchet wrench is rotated counter clockwise, the second face 142 contacts the fourth face 416.

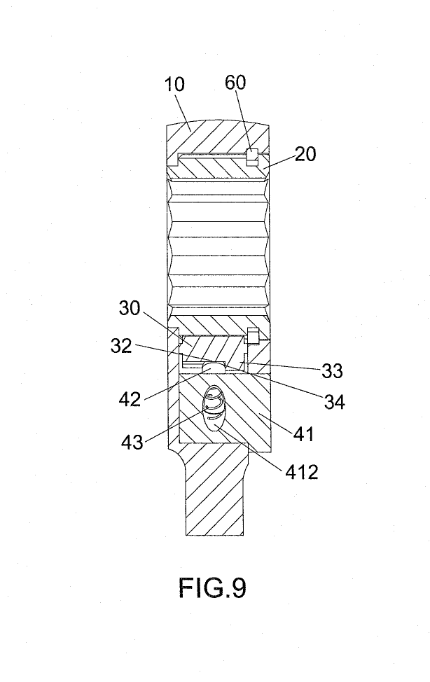

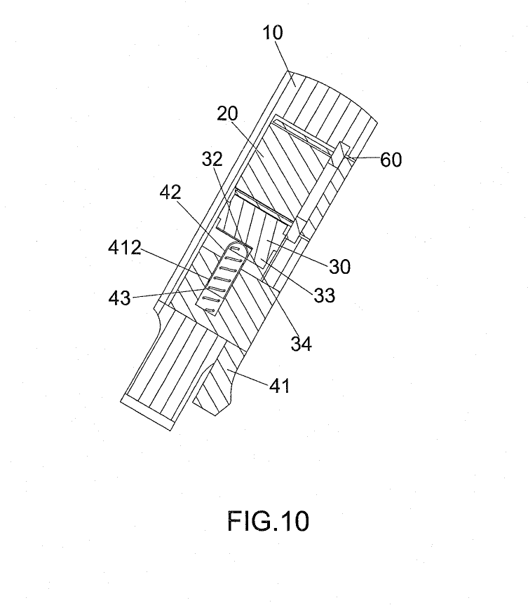

As shown in FIGS. 9 and 10, the pawl 30 is located in the second recess 12, and the end piece 42 is biased by the resilient member 43 and contacts against the inner side of the curved recess 32. The end piece 42 contacts the contact face 34 of the pawl 30. The end piece 42 is restricted by the contact face 34 to position the switch unit 40 in the third recess 13. The end piece 42 is restricted by the second height 36 of the protrusion 33 to make the end piece 42 aim the central portion of the pawl 30, and the pawl 30 is engaged with the ratchet wheel 20 optimally. The C-shaped clip 60 is engaged between the groove 110 of the body 10 and the engaging groove 23 of the ratchet wheel 20 to position the ratchet wheel 20 in the first recess 11.

The present invention has the following advantages:

The protrusion 33 of the pawl 30 partially performs as a rib to increase the stiffness of the pawl 30. The pawl 30 can be made by tow different methods.

The end piece 42 contacts the contact face 34 of the pawl 30. The end piece 42 is restricted by the contact face 34 to position the switch unit 40 in the third recess 13. The end piece 42 is restricted by the second height 36 of the protrusion 33 to make the end piece 42 aim the central portion of the pawl 30, and the pawl 30 is engaged with the ratchet wheel 20 optimally.

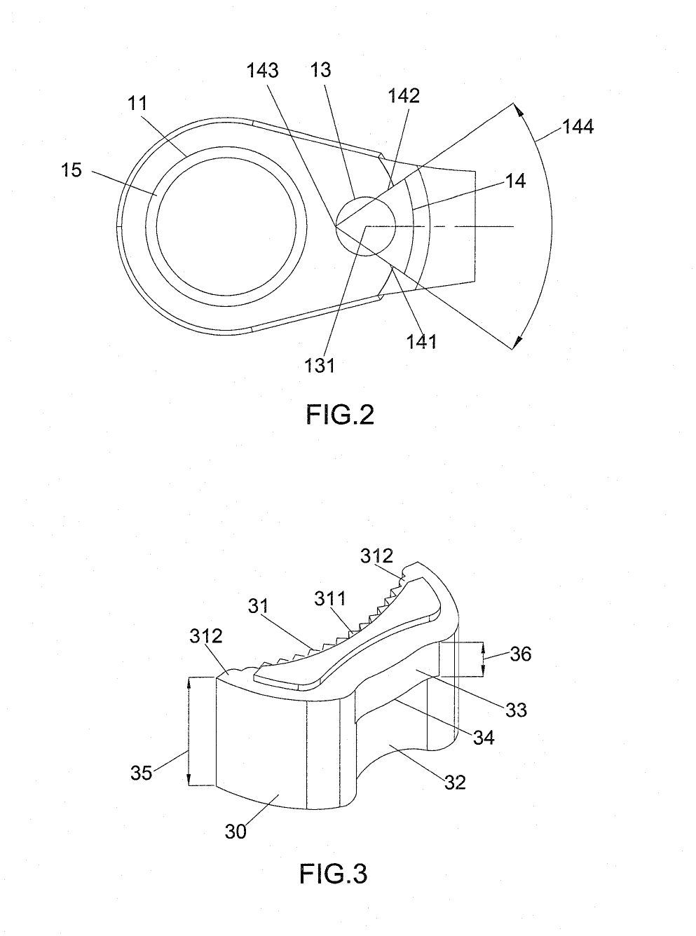

As shown in FIGS. 2 and 3, the driving portion 31 has multiple teeth 311 and two curved teeth 312 are located at each of the two ends of the row of the teeth 311, when cooperated with the switch unit 40, the ratchet wrench can be rotated in two different directions.

The second end face 413 is in flush with the first end face 16, the lever 414 is located in the opening 14 to avoid the lever 414 from being unintentionally switched.

The lever 414 is located in the opening 14, and the lever 414 is restricted its pivoting action between the third and fourth faces 415, 416 so as to avoid the end piece 42 from touching the inside of the second recess 12 and the third recess 13, or the intersection area.

The switch member 41 only needs a restriction groove to accommodate the end piece 42 and the resilient member 43. The structure is simple and the material cost is reduced.

While we have shown and described the embodiment in accordance with the present invention, it should be clear to those skilled in the art that further embodiments may be made without departing from the scope of the present invention.

1. A ratchet wrench comprising:
a body having a handle, a function head connected to an end of the handle, the function head having a first recess defined therethrough, a second recess defined in an inner periphery of the first recess, a center of the second recess being located within the first recess, the second recess having a closed top and a close bottom, a third recess defined in an inner periphery of the second recess, the third recess communicating with a top of the function head, the third recess having a center at a center thereof, an opening defined in the top of the function head and communicating with the third recess, the opening located between a first plane face and a second plane face, an extension line from the first plane face and an extension line from the second plane face intersecting at an intersection point, a distance between the intersection point and the first recess being shorter than a distance between the center and the first recess, the function head having an end face on a top thereof, a first angle defined between the first and second plane faces, the first angle being within a range between 60 to 80 degrees, a groove defined in an inner periphery of the first recess;
a ratchet wheel rotatably received in the first recess and having a toothed portion defined in an outer periphery thereof, the toothed portion having multiple teeth, an engaging groove defined in the outer periphery of the ratchet wheel, the ratchet wheel having a mounting portion formed at a center thereof;
a pawl movably located in the second recess and having a driving portion formed in a front side thereof, the driving portion having multiple teeth and multiple curved teeth, the teeth of the driving portion of the pawl engaged with the teeth of the ratchet wheel, when the curved teeth are located between two of the teeth of the ratchet wheel, the curved teeth are tangent to the two teeth of the ratchet wheel, a bottom of each of the teeth and the curved teeth of the pawl being located along a second curve, two to four curved teeth being located at each of two ends of a row of the teeth of the pawl, a top of each of the teeth of the pawl being located along a first curve, the first curve, the second curve, the first recess and the ratchet wheel sharing a common center, a third curve located between the first and second curve, a top of each of the curved teeth being tangent to the third curve, a curved recess defined in a rear side of the pawl and a protrusion located on an upper portion of the curved recess, the protrusion having a contact face at an underside thereof, the pawl having a first height and the protrusion having a second height which is smaller than a half of the first height, a radius of the third curve is a half of a sum of a radius of the first curve and a radius of the second curve;
a switch unit located in the third recess to control a movement of the pawl in the second recess, the switch unit having a switch member, an end piece and a resilient member, the switch member having a cylindrical member which is rotatably located in the third recess, the cylindrical member having a restriction groove which is located corresponding to the curved recess, the switch member having a second end face on a top thereof, the second end face being in flush with the first end face, a lever extending from the switch member and located in the opening, the lever having a third plane face and a fourth plane face respectively formed on two sides thereof, the third plane face contacting the first plane face, the fourth plane face contacting the second plane face, the end piece and the resilient member located in the restriction groove, the resilient member located between the end piece and the restriction groove, the end piece being biased by the resilient member and contacting against an inner side of the curved recess, an outside of the end piece contacting the contact face of the pawl to position the switch unit in the third recess, the end piece being restricted by the second height of the protrusion to make the end piece aim a central portion of the pawl and a mediate portion of the first height, and
a C-shaped clip being engaged with the groove of the body and the engaging groove of the ratchet wheel to position the ratchet wheel in the first recess.

2. The ratchet wrench as claimed in claim 1, wherein a flange extends inward from the inner periphery of the first recess, the ratchet wheel has a contact portion which contacts the flange.

3. The ratchet wrench as claimed in claim 1, wherein the mounting portion is a polygonal recess or a rectangular protrusion.

4. (canceled)
